(19) United States
(12) Patent Application Publication
(10) Pub. No.: US 2026/0266766 A1
(43) Pub. Date: Sep. 10, 2026

(54) SAW SENSOR MODULE

(71) Applicant: BIO SAW GMBH, Dresden (DE)

(72) Inventors: Steffen Zietzschmann, Priestewitz / OT Gaevernitz (DE); Thomas Ostertag, Geretsried (DE)

(21) Appl. No.: 19/165,846

(22) PCT Filed: Mar. 8, 2024
(86) PCT No.: PCT/IB2024/052250

§ 371 Date: Sep. 16, 2025

(30) Foreign Application Priority Data
Mar. 16, 2023 (EP) 23162327.3

(51) Int. Cl. G01N 29/02; G01N 29/24

(52) U.S. Cl. CPC G01N 29/022; G01N 29/2462

(57) ABSTRACT

A SAW sensor module includes a cartridge having a sensor chip of piezoelectric material and at least one SAW sensor formed thereon and at least one controlling and reading device for the at least one SAW sensor. The controlling and reading device has a device circuit board, on the front side of which device coupling electrodes are formed which are connected, by electric lines guided through the device circuit board, to a device connection formed on the device circuit board. The cartridge has cartridge coupling electrodes, which are each capacitively coupled on one side to the device coupling electrodes and on the other side to sensor electrodes of the at least one SAW sensor. At least one magnet element is formed on the device circuit board and the cartridge has at least one metal and/or magnetic orientation element oriented to the at least one magnet element.

The present invention relates to a SAW sensor module which has a cartridge with a sensor chip of piezoelectric material and at least one SAW sensor formed thereon and at least one control and reading device for the at least one SAW sensor.

A surface acoustic wave (SAW) is an acoustic surface wave, i.e. a structure-borne sound wave, which propagates in a planar manner on a surface, i.e. only in two dimensions. SAW waves penetrate only minimally into the material on which they propagate, the penetration depth is limited to one wavelength.

In a SAW sensor, an acoustic surface wave is transmitted from a transmitter electrode located on a sensor surface to a receiver electrode. The respective selective receptor layer is located between the transmitter electrode and the receiver electrode on a piezoelectric substrate.

Metallic interdigitated comb structures (so-called interdigital transducers-IDTs) are preferably used as the transmitter and receiver. An AC voltage is then applied to the one comb structure, while the other comb structure is applied to ground. This results in a periodically changing electric field between the differently charged fingers. Since, in the case of the piezoelectric substrate, an electric field applied from the outside causes the mechanical deformation thereof, the substrate is thereby alternately stretched and contracted.

In the SAW sensor, two of these IDTs are applied next to one another on the sensor substrate. One IDT serves as a transmitter and the other IDT serves as a receiver. At the transmitter, the AC voltage signal is converted into an acoustic surface wave and emitted into the substrate. The acoustic surface wave in the piezoelectric substrate causes charge displacements that generate an AC voltage signal in the finger structures of the receiver.

SAW sensors can be operated as a delay line or as resonators. In the latter principle, reflector structures are located on the outer sides of the IDTs.

The respective irradiated radio signal is reflected as an echo by the respective reflector. The time interval between the original signal and the echo as well as the change in the magnitude and the phase of the respective signal depend, inter alia, on the speed of sound of the sensor substrate material used, the temperature and mechanical stresses in the substrate. It has also been shown that, in the case of a SAW sensor based on such a reflection, time interval, magnitude and phase change as a function of a receptor layer applied to the sensor substrate and binding to the substrate surface. The resulting mass accumulation on the sensor surface causes a change in the surface wave velocity. This effect is used, for example, in biological or chemical sample analysis in order to be able to determine certain ingredients of fluids.

It is the object of the present invention to provide a practicable device for a simple analysis of chemical and/or biological fluids based on SAW sensors.

This object is solved according to the invention by a SAW sensor module which comprises a cartridge with a sensor chip of piezoelectric material and at least one SAW sensor formed thereon and at least one control and reading device for the at least one SAW sensor, wherein the control and reading device comprises a device board, on whose device board front side device coupling electrodes are formed, which are connected to a device connection formed on the device board by means of electrical conductors passing through the device board, and the cartridge comprises cartridge coupling electrodes, which are respectively capacitively coupled to the device coupling electrodes on the one hand, and, on the other hand, to sensor electrodes of the at least one SAW sensor, wherein at least one magnetic element is formed on the device board and the cartridge comprises at least one metallic and/or magnetic alignment element aligning itself on the at least one magnetic element.

The SAW sensor module according to the invention comprises a control and reading device which can be used in a variable and permanent manner and which can be used for a plurality of measurements. In addition, the SAW sensor module according to the invention comprises a cartridge which is used in principle only once, i.e. as a disposable part. The sample-dependent measurement of the change in the generated acoustic surface waves takes place in the SAW sensor component of the cartridge. The control and reading of the SAW sensors used in the course of this is carried out by the control and reading device. In the present invention, the signal transmission from the control and reading device to the cartridge and from the latter back to the control and reading device takes place simply and with little loss via a capacitive coupling between the control and reading device and the cartridge. Two capacitive couplings are used in the course of this: On the one hand, the device coupling electrodes are arranged opposite the cartridge coupling electrodes at a very small distance from one another and can thus be coupled capacitively in a simple manner, and on the other hand, the cartridge coupling electrodes are capacitively coupled to the sensor electrodes via the piezoelectric substrate.

The respective electrodes are arranged directly one above the other. The alignment of the device coupling electrodes with respect to the cartridge coupling electrodes is achieved in the present invention simply in that, as a result of the magnetic attraction between the at least one alignment element and the at least one magnetic element, an automatic alignment of the cartridge on the control and reading device takes place. A complex adjustment and wiring is therefore not necessary in the present invention. On the contrary: the cartridge only has to be placed simply on the control and reading device, rotates from itself into the correct position and the evaluation can begin. This alignment functions both in rotation and in translation. After alignment has taken place, the cartridge is stable in all axes on the control and reading device.

In a mechanically particularly stable embodiment of the present invention, the cartridge comprises a carrier board located between the sensor chip and the device board, on which the cartridge coupling electrodes are formed. The carrier board forms a stable base, on which the cartridge coupling electrodes can advantageously be formed and on which, in addition, the sensor chip and further superstructures of the cartridge, such as its housing, can advantageously be constructed.

In principle, however, the sensor electrodes of the sensor chip can also be capacitively coupled directly to the device coupling electrodes of the device board.

Fluid can be analyzed particularly easily and safely with the aid of the SAW sensor module according to the invention if a fluid frame is constructed on the SAW sensor component, which encloses a fluid basin, and a cap is formed on the sensor chip around the fluid frame, wherein the cap and the fluid frame cover the sensor electrodes and reflectors of the at least one SAW sensor. Due to the fluid basin it is achieved that, if the SAW sensor module has a plurality of SAW sensors, the propagation paths or tracks of all of these SAW sensors can be designed to be the same length, which facilitates a subtraction between the signals of these SAW sensors.

The fluid frame forms a mechanically particularly stable and tight frame around the fluid basin when the fluid frame is a lever structure suspended on the one hand in a groove formed on the cap and on the other hand pressing on a sensor chip front side of the sensor chip and sealed there.

The fluid basin can be filled particularly easily with fluid if the fluid frame forms a funnel comprising oblique walls on the at least one SAW sensor or such a funnel is placed on the fluid frame.

The cap is preferably a plastic injection-molded part, through which the at least one alignment element runs. Thus, the cartridge can be produced with high reproducibility in high quantities and thus inexpensively.

As long as the SAW sensor module according to the invention is not yet in use, the at least one SAW sensor can be particularly effectively protected from external influences if a cover foil is laminated on the fluid frame.

If the cartridge has a plurality of strip-shaped SAW sensors arranged parallel to one another, at least one of these SAW sensors can be used as a reference sensor. For example, this reference sensor can be formed without a selective receptor layer. Furthermore, one of these SAW sensors can be used to compensate for environmental or temperature effects.

It is useful if the parts of the propagation paths of measuring and reference SAW sensors that are in contact with a fluid to be analyzed have the same length.

The SAW sensors are preferably separated from one another by means of partition walls located therebetween.

If at least two of the SAW sensors have different propagation paths, they can be electrically connected in parallel or in series and read out together via a coupling path. Signals of these sensors can then be separated with evaluation electronics on the basis of their propagation time.

In a further advantageous embodiment of the present invention, a separate capacitive connection is assigned to each of the SAW sensors. The SAW sensors can thus be measured and evaluated at the same time, as a result of which measurement errors can be reduced.

It is particularly favorable if at least one RFID chip is formed on the sensor chip and/or the carrier board, which RFID chip is connected to the device connection via at least one capacitive coupling. With the RFID chip, the cartridge and the fluid sample determination carried out therein can be unambiguously determined and associated to measurement values captured therewith, wherein the data transmission takes place simply via the at least one capacitive coupling.

An advantageous protection of the control and reading device against dirt or moisture, for example, is achieved if a dielectric protective membrane is arranged between the cartridge and the control and reading device. Such a protective membrane serves as a dielectric medium for the capacitive coupling between the control and reading device and the cartridge and does not impair it.

Preferred embodiments of the present invention, the structure, function and advantages of which are explained in more detail below with reference to figures, wherein

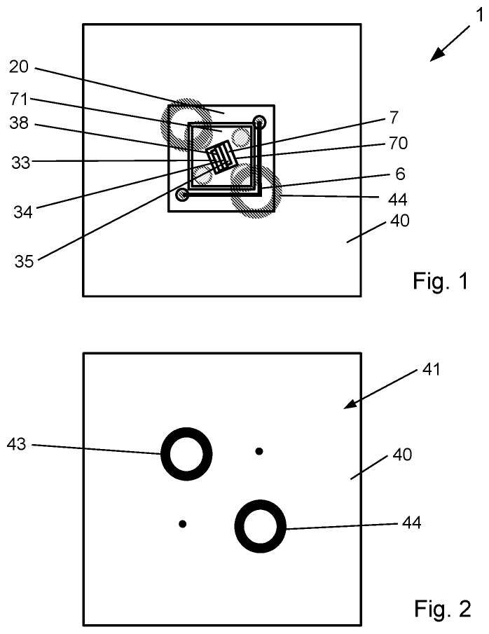

FIG. 1 schematically shows an embodiment of a SAW sensor module according to the invention in a plan view;

FIG. 2 schematically shows a device board of the SAW sensor module of FIG. 1 in a plan view;

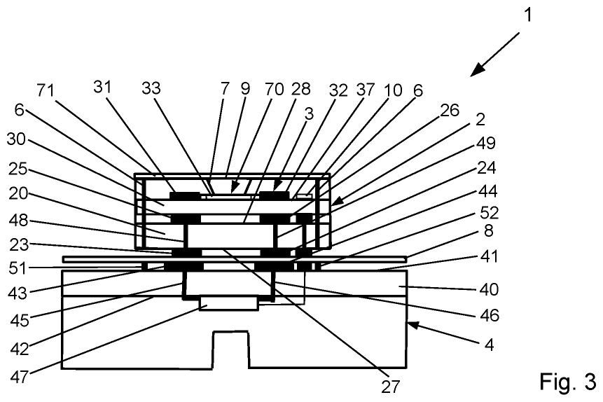

FIG. 3 schematically shows an embodiment of a SAW sensor module according to the invention in a sectional side view;

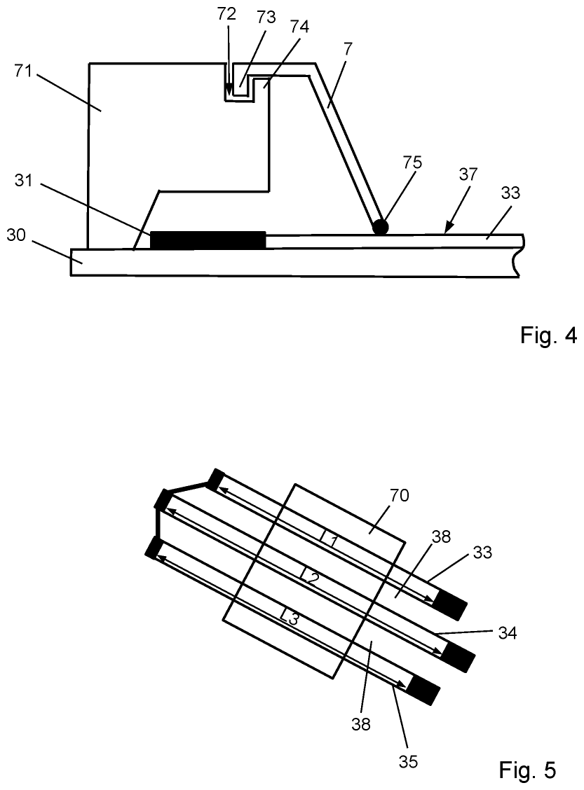

FIG. 4 schematically shows a part of a sensor chip, a cap and a fluid basin of an embodiment of the SAW sensor module according to the invention in a sectional side view; and

FIG. 5 schematically shows a plan view of SAW sensors of an embodiment of the SAW sensor module according to the invention.

FIG. 1 schematically shows an embodiment of a SAW sensor module 1 according to the invention in a plan view. Concealed structures of the SAW sensor module 1 are shown in gray. FIG. 3 schematically shows an embodiment of the SAW sensor module 1 according to the invention in a sectional side view.

The SAW sensor module 1 comprises a control and reading device 4, schematically illustrated in FIG. 3, with a device board 40, which is shown individually in a plan view in FIG. 2. The device board 40 is an electrically non-conductive printed circuit board on which electrically conductive structures are formed. The device board 40 has two device coupling electrodes 43, 44 on its device board front side 41 shown in FIG. 2, which device coupling electrodes 43, 44 are circular ring-shaped in the embodiment shown, but can also have other shapes.

The device coupling electrodes 43, 44 are connected to an electrical device connection 47 on the device board back side 42 via electrical conductors 45, 46 passing through the device board 40. Furthermore, the device board 40 comprises two magnetic elements 51, 52, which are accessible via the device board front side 41. In other embodiments of the invention, only one magnet element or more than two magnet elements 51, 52 may also be formed on the device board front side 41.

A cartridge 2 is placed on the control and reading device 4. The control and reading device 4 is intended for a permanent use, while the cartridge 2 is designed for a single use, i.e. as a disposable element. A dielectric protective membrane 8, such as a Kapton tape, is arranged between the control and reading device 4 and the cartridge 2.

The cartridge 2 comprises a SAW sensor component 3. In the embodiment shown, the SAW sensor component 3 comprises a carrier board 20 and a sensor chip 30 with at least one SAW sensor 33 located thereon, preferably a plurality of SAW sensors 33, 34, 35. In other embodiments of the invention, which are not shown, the SAW sensor component 3 can also comprise only one single substrate, which combines the elements of the carrier board 20 and of the sensor chip 30 described below on this substrate.

On its carrier board back side 27, the carrier board 20 comprises cartridge coupling electrodes 23, 24 on the back side which are located opposite the device coupling electrodes 43, 44. In the embodiment shown, the device coupling electrodes 43, 44 have a larger diameter than the back side cartridge coupling electrodes 23, 24. The device coupling electrodes 43, 44 and the back side cartridge coupling electrodes 23, 24 formed on a cartridge back side 27 of the cartridge 2 can be formed concentrically with respect to one another, but do not have to be formed in such a way.

Only the dielectric protective membrane 8 is located between the back side cartridge coupling electrodes 23, 24 and the device coupling electrodes 43, 44. Since the control and reading device 4 must be regularly disinfected, an advantageous protection from disinfectants, but also against dirt and generally from moisture, can be provided by the dielectric protective membrane 8. The back side cartridge coupling electrodes 23, 24 and the device coupling electrodes 43, 44 are not coupled via electrical conductors, but capacitively.

On a carrier board front side 28 of the carrier board 20, front side cartridge coupling electrodes 25, 26 are electrically conductively connected to the back side cartridge coupling electrodes 23, 24 via electrical conductors 48, 49 passing through the carrier board 20.

In the embodiment shown, the carrier board 20 is a printed circuit board made of electrically non-conductive material on which electrically conductive structures are formed. The carrier board 20 serves to produce a capacitive coupling between the sensor chip 30 of the cartridge 2 and the control and reading device 4. Furthermore, the carrier board 20 has a carrier function by carrying the sensor chip 30. Furthermore, fitting components, such as inductors and/or capacitors, can be provided on the carrier board 20 for power adjustment purposes.

The carrier board 20 can also comprise markings which can be used to place the sensor chip 30 on the carrier board 20.

On the carrier board 20, the electrical connections between the electrical contacts or electrodes on the carrier board front side 28 and the carrier board back side 27 can be designed as desired. This provides mechanical and electrical freedoms.

The sensor chip 30 consists of piezoelectric material. The sensor chip 30 comprises the at least one SAW sensor 33 on its sensor chip front side 37. The at least one SAW sensor 33 is operated by means of sensor electrodes 31, 32 which are likewise located on the sensor chip front side 37.

The sensor electrodes 31, 32 are capacitively coupled to the front side cartridge coupling electrodes 25, 26. The piezoelectric material of the sensor chip 30 forms a dielectric medium of this capacitive coupling arrangement.

Typically, the sensor chip 30 is glued to the carrier board 20. The adhesive used then forms part of the above-mentioned dielectric medium.

Thus, the sensor electrodes 31, 32 are connected via the front side cartridge coupling electrodes 25, 26, the back side cartridge coupling electrodes 23, 24 and the device coupling electrodes 43, 44 to the device connection 47 of the control and reading device 4, so that the at least one SAW sensor 33 can be electrically contacted and the signals thereof can be read out.

A fluid basin 70 is formed in the cartridge 2 above the at least one SAW sensor 33. The fluid basin 70 is delimited laterally by a fluid frame 7.

As shown schematically in FIG. 4, the fluid frame 7 can be formed by oblique walls which form a funnel on the sensor chip 30 above the at least one SAW sensor 33. As can be seen in FIG. 4, the oblique walls can be designed in the form of levers which, on the one hand, are suspended in a groove 72 of a cap 71 surrounding the fluid basin 70 and, on the other hand, rest on the sensor chip 30, against which they are sealed by means of a seal 75. The seal 75 can be, for example, an adhesive bead.

In the embodiment shown, the cap 71 is formed as a plastic injection-molded part.

The cap 71 together with the fluid frame 7 covers the sensor electrodes 31, 32 and reflectors of the at least one SAW sensor 33.

A fluid to be detected can be introduced into the fluid basin 70. The size of the fluid basin 70 defines the analyzable fluid volume. Molecules of such a fluid can bind to the surface of the at least one SAW sensor 33, whereby its surface wave conduction properties can change, whereby the corresponding fluid can be detected.

As long as the cartridge 2 is not in use, the fluid basin 70 is covered by a cover foil 9. The cover foil 9 can be pulled off.

In the embodiment shown, at least one RFID chip 10 is arranged on the sensor chip 30. The RFID chip 10 is also capacitively coupled via the sensor chip 30 to cartridge coupling electrodes of the carrier board 2 which is in turn capacitively coupled to device coupling electrodes of the device board 40. With the RFID chip 10, the cartridge 2 and the fluid sample determination carried out therein can be unambiguously determined and associated to measurement values captured therewith. In other embodiments of the invention, the RFID chip 10 can also be arranged on the carrier board 20.

The RFID chip 10 is preferably not an RFID chip constructed on the basis of SAW but on a semiconductor basis. For example, the RFID chip 10 can serve to record, which test is currently carried out by the SAW sensor module 1. The RFID chip 10 can also be used to read out whether the SAW sensor module 1 was already used. Furthermore, batch number, durability data, etc. may be stored in the RFID chip 10.

In the embodiment shown, three SAW sensors 33, 34, 35 are formed on the sensor chip 30. As shown schematically in FIG. 5, the SAW sensors 33, 34, 35 have different propagation paths L1, L2, L3. Thus, the signals of the SAW sensors 33, 34, 35 can be easily distinguished from one another.

In the embodiment shown, SAW sensors 33, 34, 35 are 300 MHz SAW sensors, but can also be SAW sensors based on a different frequency. The SAW sensors 33, 34, 35 are strip-shaped and parallel to one another. The fluid basin 70 is located above a central region of the SAW sensors 33, 34, 35.

Photolithographically generated partition walls 38 are located between the SAW sensors 33, 34, 35. The partition walls 38 protect the individual regions of the SAW sensors 33, 34, 35, but also their IDTs from one another.

Furthermore, a cover is formed over regions of the sensor chip 30 that are not in contact with a fluid to be analyzed. The cover is formed by photolithographic layer structuring.

In the embodiment shown, the SAW sensors 33, 34, 35 are connected in series and use only one common pair of capacitive coupling electrodes for contacting. However, this does not necessarily have to be, for example, the SAW sensors 33, 34, 35 could be successively controlled and read out via a multiplexer. A parallel connection of the individual SAW sensors 33, 34, 35 is also possible.

In the embodiment shown in FIG. 5, the SAW sensor 33 forms a sample channel, i.e. the actual measuring channel, the SAW sensor 34 forms a compensation channel for compensating temperature effects, and the SAW sensor 35 forms a reference channel, i.e. does not comprise a selective receptor layer.

In other embodiments of the present invention, the SAW sensors 33, 34, 35 may also be used to measure different analytes.

A metallic or magnetic alignment element 6 is guided through the cartridge 2, which is formed from a metallic wire, such as a steel wire, in the embodiment shown. The at least one alignment element 6 is advantageously guided through prefabricated bores in the cartridge 2, for example in corners of the cartridge 2. Instead of the steel wire, a magnetic field yoke can also be used as alignment element 6.

The ends of the alignment element 6 terminate at the carrier board back side 27, opposite the magnetic elements 51, 52. Due to the interaction between the ends of the alignment element 6 and the magnetic elements 51, 52, the cartridge 2 automatically aligns with the device board 40 when it is placed on the device board 40. As a result of this automatic alignment, the cartridge coupling electrodes 23, 24 automatically lie on the device coupling electrodes 43, 44.

1-13. (canceled)

14. A SAW sensor module, comprising:
a cartridge having a sensor chip of piezoelectric material, said cartridge having at least one SAW sensor formed on said sensor chip, said cartridge having cartridge coupling electrodes, and said cartridge including at least one alignment element being at least one of metallic or magnetic;
said at least one SAW sensor having sensor electrodes;
at least one control and reading device for said least one SAW sensor, said at least one control and reading device including a device board having a device board front side;
a device connection formed on said device board;
device coupling electrodes formed on said device board front side;
electrical conductors passing through said device board and connecting said device coupling electrodes to said device connection;
said cartridge coupling electrodes being capacitively coupled to said device coupling electrodes and to said sensor electrodes; and
at least one magnetic element formed on said device board, said at least one alignment element aligning with said at least one magnetic element.

15. The SAW sensor module according to claim 14, wherein said cartridge includes a carrier board located between said sensor chip and said device board, said cartridge coupling electrodes being formed on said carrier board.

16. The SAW sensor module according to claim 14, which further comprises:
a SAW sensor component;
a fluid frame constructed on said SAW sensor component, said fluid frame enclosing a fluid basin;
a cap formed on said sensor chip around said fluid frame;
said at least one SAW sensor having reflectors; and
said cap and said fluid frame covering said sensor electrodes and said reflectors.

17. The SAW sensor module according to claim 16, wherein said sensor chip has a sensor chip front side, and said fluid frame is a lever structure suspended in a groove formed in said cap and pressing on and being sealed against said sensor chip front side.

18. The SAW sensor module according to claim 16, wherein said fluid frame forms a funnel including oblique walls disposed on said at least one SAW sensor or placed on said fluid frame.

19. The SAW sensor module according to claim 16, wherein said cap is a plastic injection-molded part through which said at least one alignment element runs.

20. The SAW sensor module according to claim 16, which further comprises a cover film laminated over said fluid frame.

21. The SAW sensor module according to claim 14, wherein said at least one SAW sensor of said cartridge includes a plurality of strip-shaped SAW sensors disposed parallel to one another.

22. The SAW sensor module according to claim 21, which further comprises partition walls formed between said plurality of SAW sensors.

23. The SAW sensor module according to claim 21, wherein at least two of said plurality of SAW sensors have different propagation paths.

24. The SAW sensor module according to claim 21, which further comprises a separate respective capacitive connection associated with each of said plurality of SAW sensors.

25. The SAW sensor module according to claim 15, which further comprises at least one RFID chip formed on at least one of said sensor chip or said carrier board, said at least one RFID chip being connected to said device connection by at least one capacitive coupling.

26. The SAW sensor module according to claim 14, which further comprises a dielectric protective membrane disposed between said cartridge and said control and reading device.
